(19) United States
(12) Patent Application Publication
(10) Pub. No.: US 2017/0318630 A1
(43) Pub. Date: Nov. 2, 2017

(54) COOKING HOUSEHOLD APPLIANCE

(71) Applicant: BSH Hausgeräte GmbH, Munich (DE)

(72) Inventors: Mathias Frey, Rosenheim (DE); Wojciech Gwarek, Warszawa (PL); Markus Kuchler, Gstadt am Chiemsee (DE); Andreas Nitschke, Traunreut (DE)

(21) Appl. No.: 15/528,122

(22) PCT Filed: Oct. 30, 2015
(86) PCT No.: PCT/EP2015/075220

§ 371 Date: May 19, 2017

(30) Foreign Application Priority Data
Nov. 25, 2014 (DE) 10 2014 224 053.0

(51) Int. Cl. H05B 6/76

(52) U.S. Cl. CPC H05B 6/763

(57) ABSTRACT

A cooking household appliance includes a magnetron for generating microwaves, a muffle for receiving food to be cooked, a door for closing the muffle, and a microwave trap arranged between a muffle flange of the muffle and an arched base of the door. The microwave trap is flexible to adapt its contour to the arched door base and is fastened to the arched door base.

The present invention relates to a household cooking appliance.

With household cooking appliances with a magnetron for generating microwaves, various microwave trap systems are known for shielding and reducing the microwave leakage rate of the household cooking appliance. The microwave leakage rate is understood to mean a microwave power per unit area which escapes from the household cooking appliance.

U.S. Pat. No. 4,794,218 A describes a door for a microwave oven. A microwave trap is connected to and provided on the door. The microwave trap has slots.

Against this background an object of the present invention consists in providing an improved household cooking appliance.

Accordingly a household cooking appliance having a magnetron for generating microwaves, a muffle for receiving food to be cooked, a door for closing the muffle and a microwave trap is proposed, said microwave trap being arranged between a muffle flange of the muffle and a door base of the door, wherein the door base is arched, wherein the microwave trap is flexible in order to adapt its contour to the arched door base and wherein the microwave trap is fastened to the arched door base.

The fact that the door base is arched and the microwave trap is adapted to the arch of the door base means that the trapping effect is improved in particular in the corner regions of the door. The microwave trap and the door base are preferably manufactured separately and then joined together. This permits a simple and cost-effective design of the required bending tool and compression mold, since otherwise a significant manufacturing outlay would occur on account of the curvature of the microwave trap. The door base is preferably square-shaped. The household cooking appliance can be a microwave oven or a conventional oven with microwave function for instance.

According to one embodiment, the muffle flange is arched so as to correspond to the door base, so that a uniform door gap is provided between the muffle flange and the door base.

This improves the trapping effect of the microwave trap.

According to a further embodiment, the door base is arched in a spherical manner.

A first segment or fastening segment of the door base is preferably arched in a spherical, in particular hemispherical, manner. In particular the door base is arched in a spherical segment-shaped manner.

According to a further embodiment, the door base is arched in a concave manner in respect of the muffle.

In particular, the arch of the door base points away from the muffle.

According to a further embodiment, the door base and the microwave trap are separate components.

In particular, the microwave trap is bent from a comb-shaped sheet metal part. As a result of the door base and the microwave trap being embodied as separate components, the microwave trap can be aligned precisely with the door base upon connection to it.

According to a further embodiment, the microwave trap is welded, in particular laser-welded, to the door base.

In particular the microwave trap can be positioned in a welding tool relative to the door base, as a result of which tight tolerance requirements can be maintained.

According to a further embodiment, the microwave trap is a Lambda quarter-wave trap.

According to a further embodiment, the microwave trap is comb-shaped.

According to a further embodiment, the microwave trap has a fastening segment for fastening the microwave trap to the door base and a trap segment, wherein the trap segment is slotted such that it has alternating trap teeth and trap slots.

According to a further embodiment, a ratio of a trap tooth width of the trap teeth to a trap slot width of the trap slots is two.

The trap teeth preferably have a width of 3 to 5 millimeters, further preferably of 3.5 to 4.5 millimeters, further preferably of 4 millimeters. The trap slots preferably have a width of 1 to 3 millimeters, further preferably of 1.5 to 2.5 millimeters, further preferably of 2 millimeters. The repeating period is preferably 6 millimeters wide with a ratio of trap tooth width to trap slot width of 2.

Further possible implementations of the household cooking appliance also comprise combinations—not explicitly cited—of features or forms of embodiment described above or below in respect of the exemplary embodiments. Here the person skilled in the art will also add individual aspects as improvements or amendments to the respective basic form of the household cooking appliance.

Further advantageous embodiments and aspects of the household cooking appliance are the subject matter of the dependent claims as well as the exemplary embodiments of the household cooking appliance described below. The household cooking appliance is explained in more detail below on the basis of preferred embodiments with reference to the appended figures.

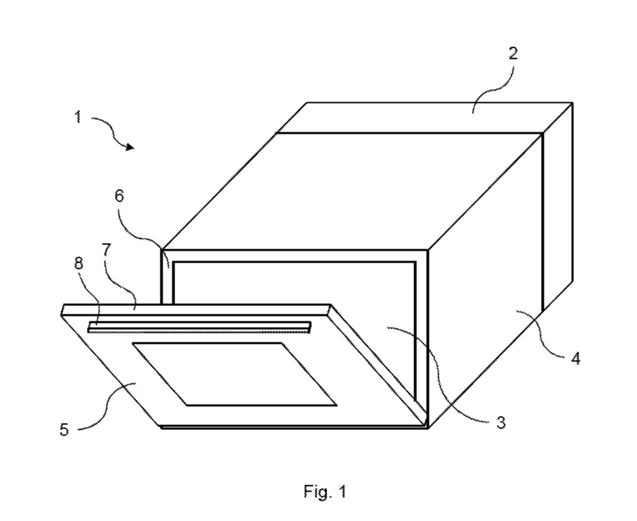

FIG. 1 shows a schematic perspective view of an embodiment of a household cooking appliance;

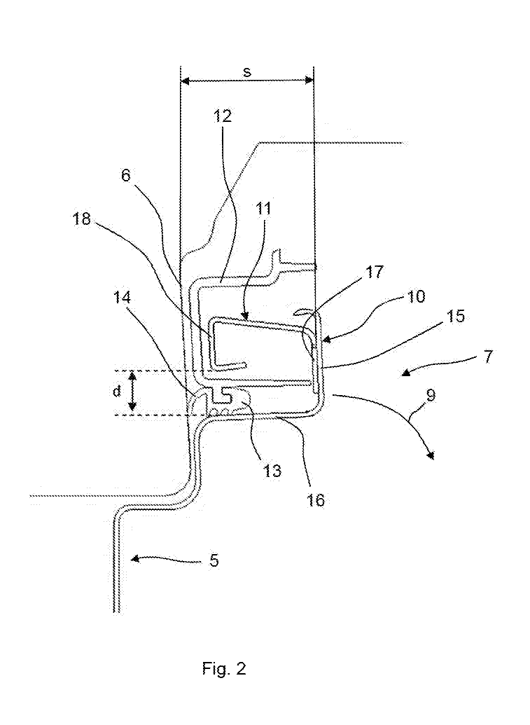

FIG. 2 shows a schematic sectional view through a muffle flange of the household cooking appliance according to FIG. 1;

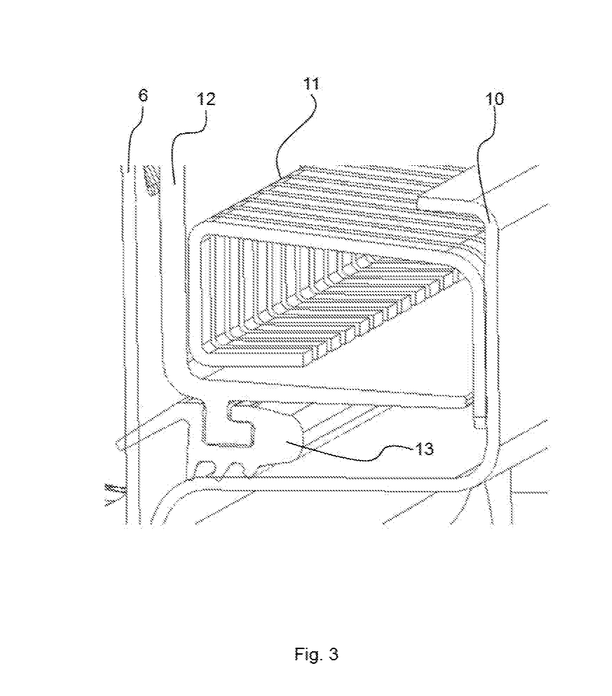

FIG. 3 shows a further schematic sectional view through the muffle flange according to FIG. 2;

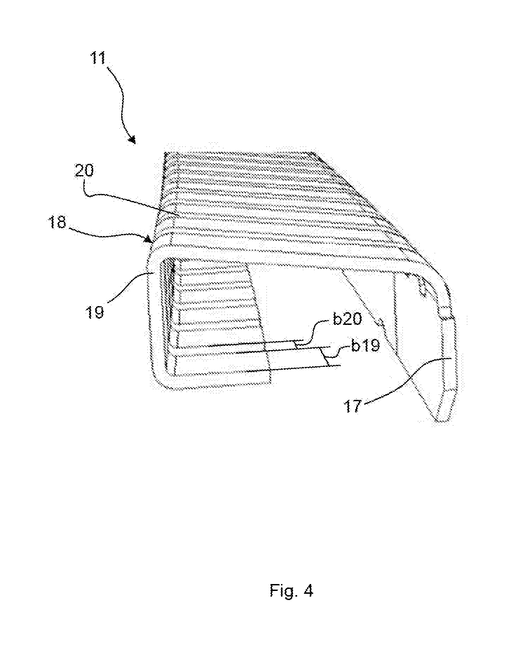

FIG. 4 shows a schematic perspective view of an embodiment of a microwave trap for the household cooking appliance according to FIG. 1;

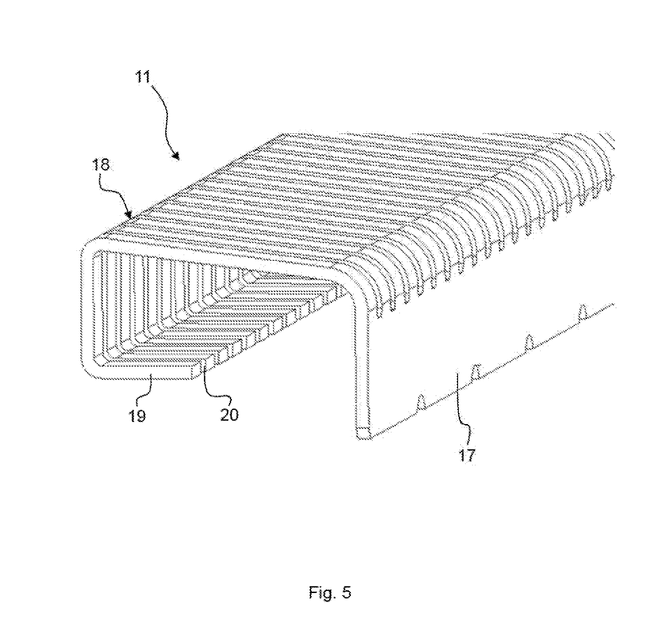

FIG. 5 shows a further schematic perspective view of the microwave trap according to FIG. 4, and

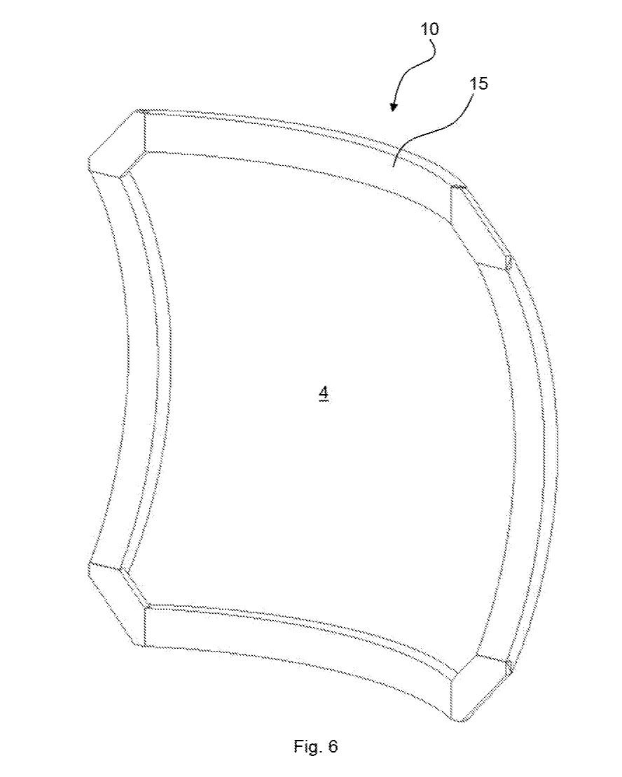

FIG. 6 shows a schematic perspective view of a door base of a door for the household cooking appliance according to FIG. 1.

Elements which are the same or function the same have been provided with the same reference characters in the figures, unless specified otherwise.

FIG. 1 shows a schematic perspective view of a household cooking appliance 1. The household cooking appliance 1 has a magnetron 2 for generating microwaves. The household cooking appliance 1 can be a microwave oven or a conventional oven with microwave function for instance. The household cooking appliance 1 further has a cooking compartment 3, which is enclosed by a muffle 4 of the household cooking appliance 1. The muffle 4 can be closed with the aid of a door 5. The muffle 4 has in particular a square-shaped geometry. In the orientation in FIG. 1, a muffle flange 6 of the muffle 4 is provided on the front. The door 5 can be pivotably attached to the muffle flange 6. As shown in FIG. 1, the door 5 can be pivotably attached at a lower end to the muffle flange 6. Alternatively, the door 5 can also be fixed laterally or fastened to a removable oven carriage. A handle 8 can be arranged on an upper segment 7 of the door 5. In FIG. 1 the door 5 is shown in a half-opened state.

FIGS. 2 and 3 each show a schematic sectional view through the upper segment 7 of the door 5 with the muffle flange 6. In the closed state shown in FIGS. 2 and 3, the door 5 can be folded in the direction of an arrow 9 into the opened state shown in FIG. 1. A microwave trap 11 is arranged between the muffle flange 6 and a door base 10 of the door 5. The door base 10 can be a steel sheet.

The microwave trap 11 is designed to prevent microwaves from escaping from the cooking compartment 3. The microwave trap 11 is in particular what is known as a Lambda quarter-wave trap. The door 5 can comprise the microwave trap 11. The door 5 further comprises a top frame assembly 12 for covering the microwave trap 11 and a sealing device 13 attached between the top frame assembly 12 and the door base 10. The top frame assembly 12 is preferably manufactured from a plastic material. The sealing device 13 is fastened to the top frame assembly 12. The top frame assembly 12 is an integral part of the door 5. The sealing device 13 has a sealing lip 14 which is designed to seal the door 5 from the muffle flange 6. The sealing lip 14 can preferably be deformed in a spring-elastic manner. The sealing device 13 is manufactured from a temperature-resistant plastic material for instance.

The door base 10 has a fastening segment or first segment 15, to which the microwave trap 11 is fastened. Furthermore, the door base 10 has a second segment 16 arranged at right angles to the first segment 15. The sealing device 13 is arranged between the second segment 16 and the top frame assembly 12. The microwave trap 11 has a fastening segment 17, which is fastened to the first segment 15 of the door base 15. The fastening segment 17 is preferably welded, in particular laser-welded, to the first segment 15 of the door base 10. The microwave trap 11 also has a trap segment 18. The trap segment 18 is designed to reduce a microwave leakage rate of the household cooking appliance 1. A microwave leakage rate is understood to mean a microwave power per unit area which escapes from the household cooking appliance 1. The trap segment 18 is arranged spaced from the second segment 16 of the door base 10 by a distance d.

FIGS. 4 and 5 show the microwave trap 11 in a schematic perspective view in each case. The microwave trap 11 is slotted except for the fastening segment 17. The trap segment 18 is slotted in particular such that it has alternating trap teeth 19 and trap slots 20. The microwave trap 11 can be deformed or bent in any way by the deep slotting therein. The microwave trap 11 is preferably embodied in a comb shape.

FIG. 6 shows the first segment 15 of the door base 10 in a schematic perspective view. In the orientation in FIG. 6, the muffle 4 is arranged behind the door base 10. The door base 10 and in particular the first segment 15 of the door base 10 is arched in a spherical manner. The door base 10 is arched in a spherical, in particular hemispherical, manner. As a result of the microwave trap 11 being flexible, its contour can be adapted to the arched door base 10. The muffle flange 6 is preferably arched so as to correspond to the door base 10, so that a uniform door gap s (FIG. 2) is provided between the muffle flange 6 and the door base 10. The door base 10 is preferably arched in a concave manner in respect of the muffle 4. In other words, the door base 10 is arched away from the muffle 4.

The door base 10 and the microwave trap 11 are in particular separate components. When the microwave trap 11 is connected to the door base 10 and in particular to the first segment 15 of the door base 10, the microwave trap 11 and the door base 10 are connected mechanically and electrically. For instance, the microwave trap 11 and the door base 10 can be welded. To this end the as yet unconnected components can be positioned exactly in respect of one another in a tool of a welding apparatus so that the distance d in particular can be maintained with high precision.

The microwave radiation present in the interior of the muffle 4 strikes the microwave trap 11 at different angles of incidence θ. With the inclined incidence of a microwave, the effective trap length of a non-slotted microwave trap extends by the factor 1/cos (θ). Accordingly, the effective frequency also varies with the effective trap length so that a non-slotted microwave trap no longer functions optimally with arbitrary angles of incidence. With household cooking appliances with large muffle dimensions, this effect is particularly pronounced since different angles of incidence can occur here in a very broad spectrum. If the microwave trap is not subdivided by slots, surface currents can flow unhindered in the wave propagation direction.

In contrast the trap slots 20 of the previously described microwave trap 11 prevent this and deflect the surface currents in the slot direction so that the associated microwaves have a significantly smaller angle of incidence 0 which is so small that the incidence condition almost corresponds to a microwave entering in the perpendicular direction.

In a preferred embodiment, the microwave trap 11 is bent from a metal comb, the trap teeth 19 of which have a trap tooth width b19 of four millimeters and a trap slot width b20 of the trap slots 20 of two millimeters for instance (FIG. 4). The recurring period is then six millimeters wide and has a ratio of trap tooth width b19 to trap slot width b20 of two. In the said embodiment, with the previously cited dimensions the effective length of the microwave trap 11 only extends by 0.9% with a typical operating frequency of the household cooking appliance 1 of 2.45 GHz. Here the quarter wavelength is 30.5 millimeters long, while a trap tooth 19 is four millimeters wide. The factor for determining the effective trap length is calculated in accordance with the following formula: 1/cos(arctan)4/30.5=1.00856.

Conversely, a shift of the effective trap frequency of 2.45 to 2.43 GHz corresponds to such an extension of the effective trap length. The effect of the microwave trap 11 is not significantly influenced by this minimal frequency displacement. Any period widths and ratios of the trap tooth width b19 to the trap slot width b20 are possible. The precise definition depends inter alia on a position of the microwave trap 11 and the dimensions of the door base 10.

The very deep trap slots 20 combined with a high number of trap slots 20 per length unit render the microwave trap 11 flexible and make it possible to adapt the contour of the microwave trap 11 to any curved surface of the door base 10. An improved wave-blocking effect in corner regions of the door 5 is produced by the curvature of the microwave trap 11.

In a preferred embodiment, the door base 10, to which the microwave trap 11 is welded, is shaped in a concave manner so that the arch points away from the muffle 4. The microwave trap 11 can be placed in the arched contour of the door base 10 and connected hereto without mechanical tensioning. Advantageously the opposing muffle flange 6 of the household cooking appliance 1 is also adjusted to this contour and molded in a correspondingly convex manner.

The advantage of the previously described household cooking appliance 1 compared with known household cooking appliances lies in the improved blocking effect of electromagnetic radiation escaping through the door gap s. The particular design of the microwave trap 11 with deep trap slots 20 is electrodynamically advantageous and permits a simple and tension-free assembly on curved surfaces, wherein the curved arrangement of the microwave trap 11 in turn has a positive effect on the wave blocking in corner regions of the door 5.

In known solutions, the door base and the microwave trap are usually manufactured from the same sheet metal blank. The separation of microwave trap 11 and door base 10 into two separate components, which are separately manufactured and then joined together, has an advantageous effect in terms of a simple design of the required bending tool and compression mold, since a considerable outlay would otherwise arise on account of the curvature. Furthermore, the component separation is advantageous in the respect that the molding of the door base 10 and the bending of the microwave trap 11 take place separately and thus the tolerances of the respective processes can be controlled and influenced separately from one another. A further correction possibility is provided by an alignment to one another particularly when joining the components together. In this way the dimension identified with d in FIG. 1 can be maintained with a tight tolerance.

The deep slots of the microwave trap 11 also result in a more robust joining process when connecting the microwave trap 11 and door base 10, since the microwave trap 11 molds itself to the first segment 15 of the door base 10 and curvature fluctuations and discontinuities of the first segment 15 can be effectively compensated. In this way the risk of a gap formation in places between the microwave trap 11 and the first segment 15 of the door base 10 is significantly reduced.

Although the present invention has been described on the basis of exemplary embodiments, it can be modified in a variety of ways.

### REFERENCE CHARACTERS USED

1 Household cooking appliance
2 Magnetron
3 Cooking compartment
4 Muffle
5 Door
6 Muffle flange
7 Segment
8 Handle
9 Arrow
10 Door base
11 Microwave trap
12 Top frame assembly
13 Sealing device
14 Sealing lip
15 Segment
16 Segment
17 Fastening segment
18 Trap segment
19 Trap tooth
20 Trap slot
d Distance
s Door gap
b19 Trap tooth width
b20 Trap slot width

1.-10. (canceled)

11. A household cooking appliance, comprising:
a magnetron for generating microwaves;
a muffle configured to receive food to be cooked and including a muffle flange;
a door for closing the muffle, said door including an arched door base; and
a microwave trap arranged between the muffle flange and the door base, said microwave trap being flexible to adapt its contour to the arched door base and fastened to the arched door base.

12. The household cooking appliance of claim 11, wherein the muffle flange is arched to correspond to the door base, thereby defining a uniform door gap between the muffle flange and the door base.

13. The household cooking appliance of claim 11, wherein the door base is arched in a spherical manner.

14. The household cooking appliance of claim 11, wherein the door base is arched in a concave manner in relation to the muffle.

15. The household cooking appliance of claim 11, wherein the door base and the microwave trap are separate components.

16. The household cooking appliance of claim 11, wherein the microwave trap is welded to the door base.

17. The household cooking appliance of claim 11, wherein the microwave trap is laser-welded to the door base.

18. The household cooking appliance of claim 11, wherein the microwave trap is a Lambda quarter-wave trap.

19. The household cooking appliance of claim 11, wherein the microwave trap is comb-shaped.

20. The household cooking appliance of claim 19, wherein the microwave trap has a fastening segment for fastening the microwave trap to the door base and a trap segment which is slotted and has alternating trap teeth and trap slots.

21. The household cooking appliance of claim 20, wherein a ratio of a trap tooth width of the trap teeth to a trap slot width of the trap slots is two.
